(19) United States
(12) Patent Application Publication
(10) Pub. No.: US 2025/0173481 A1
(43) Pub. Date: May 29, 2025

(54) MOTOR PARAMETER SEARCH SYSTEM AND MOTOR PARAMETER SEARCH METHOD

(71) Applicants: Hon Hai Precision Industry Co., Ltd., New Taipei City (TW); FOXCONN TECHNOLOGY GROUP CO., LTD, Shenzhen (CN)

(72) Inventors: Nien-Yi Jan, New Taipei City (TW); Yi-Rong Lin, New Taipei City (TW); CHUNG-CHIEH HUNG, New Taipei City (TW); Wen-Chia Lin, New Taipei City (TW); Yung-Hui Li, New Taipei City (TW); Yung-Sheng Liao, New Taipei City (TW)

(73) Assignees: Hon Hai Precision Industry Co., Ltd., New Taipei City (TW); FOXCONN TECHNOLOGY GROUP CO., LTD, Shenzhen (CN)

(21) Appl. No.: 18/963,539

(22) Filed: Nov. 28, 2024

Related U.S. Application Data
(60) Provisional application No. 63/603,601, filed on Nov. 28, 2023.

(51) Int. Cl. G06F 30/20; G06F 30/15; G06F 111/06

(52) U.S. Cl. CPC G06F 30/20; G06F 30/15; G06F 2111/06

(57) ABSTRACT

A motor parameter search system and a motor parameter search method are provided. The motor parameter search system includes a processing device and an input device. The processing device may execute a motor design parameter search engine to iteratively perform a parameter search operation based on a plurality of design parameters, a plurality of optimization objectives, a plurality of restriction conditions, and a plurality of historical recommended parameter combinations to generate a plurality of design parameter combinations. The design parameter combinations are sequentially input into a simulation software, so that the simulation software generates a plurality of simulation results. The processing device searches a plurality of historical simulation results in the database according to the plurality of optimization objectives to generate a recommended parameter combination.

### CROSS-REFERENCE TO RELATED APPLICATION

This application claims the priority benefit of U.S. provisional application Ser. No. 63/603,601, filed on Nov. 28, 2023. The entirety of the above-mentioned patent application is hereby incorporated by reference herein and made a part of this specification.

### BACKGROUND

### Technical Field

The disclosure relates to a data computing technology, and in particular relates to a motor parameter search system and a motor parameter search method.

### Description of Related Art

In the field of motor design, due to the extensive physical parameters encompassed within such design, designers must adjust back and forth between different physical fields, resulting in a considerable expenditure of human resources and time. Moreover, there is currently no unified and universal motor design theory, making it difficult to carry out multiple or even new topology designs. More importantly, traditional motor design cannot be optimized for multiple objectives at the same time.

### SUMMARY

A motor parameter search system and a motor parameter search method, which may effectively generate motor design parameters, are provided in the disclosure.

The motor parameter search system of the disclosure includes a processing device and an input device. The processing device executes a motor design parameter search engine, interactive interface module, data access module, simulation software, and optimal combination recommendation module. The input device is coupled to the processing device and receives multiple design parameters, multiple optimization objectives, and multiple restriction conditions. The motor design parameter search engine iteratively performs a parameter search operation according to the design parameters, the optimization objectives, the restriction conditions, and multiple historical recommended parameter combinations to generate multiple design parameter combinations. The interactive interface module sequentially inputs the design parameter combinations into the simulation software, so that the simulation software generates multiple simulation results. The data access module stores the design parameter combinations and the simulation results into a database. The optimal combination recommendation module searches multiple historical simulation results in the database according to the optimization objectives to generate a recommended parameter combination.

The motor parameter search method of the disclosure includes the following steps. Multiple design parameters, multiple optimization objectives, and multiple restriction conditions are received. A parameter search operation is iteratively performed according to the design parameters, the optimization objectives, the restriction conditions, and multiple historical recommended parameter combinations to generate multiple design parameter combinations, which are sequentially input into a simulation software, so that the simulation software generates multiple simulation results. The design parameter combinations and the simulation results are stored into a database. The historical simulation results in the database is searched according to the optimization objectives to generate a recommended parameter combination.

Based on the above, the motor parameter search system and the motor parameter search method of the disclosure may automatically generate multiple design parameter combinations which are automatically input into the simulation software to generate multiple simulation results, and a recommended parameter combination may be generated according to multiple historical simulation results.

In order to make the above-mentioned features and advantages of the disclosure comprehensible, embodiments accompanied with drawings are described in detail below.

### BRIEF DESCRIPTION OF THE DRAWINGS

FIG. 1 is a schematic diagram of a motor parameter search system of an embodiment of the disclosure.

FIG. 2 is a flowchart of a motor parameter searching method of an embodiment of the disclosure.

FIG. 3 is a schematic diagram of multiple modules of the motor parameter search system of an embodiment of the disclosure.

FIG. 4 is a schematic diagram of grouping of an embodiment of the disclosure.

FIG. 5 is a probability distribution diagram of an embodiment of the disclosure.

FIG. 6 is a flowchart of a two-stage iterative search operation of an embodiment of the disclosure.

### DETAILED DESCRIPTION OF DISCLOSED EMBODIMENTS

In order to make the content of the disclosure easier to understand, the following specific embodiments are illustrated as examples of the actual implementation of the disclosure. In addition, wherever possible, elements/components/steps with the same reference numerals in the drawings and embodiments represent the same or similar parts.

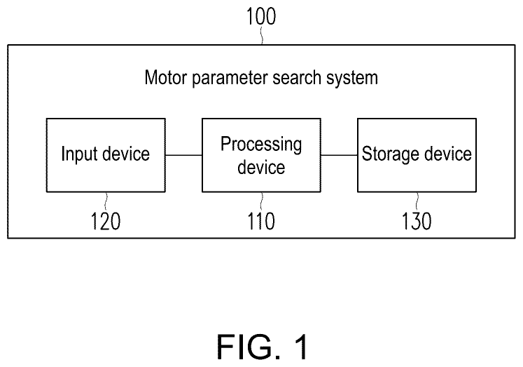

FIG. 1 is a schematic diagram of a motor parameter search system of an embodiment of the disclosure. Referring to FIG. 1, the motor parameter search system 100 includes a processing device 110, an input device 120, and a storage device 130. The processing device 110 is coupled to the input device 120 and the storage device 130. In this embodiment, the user may input multiple design parameters through the input device 120. The design parameters may be, for example, multiple motor design parameters of the electric motor of an electric vehicle, but the disclosure is not limited thereto. The processing device 110 may automatically generate multiple design parameter combinations according to the design parameters, and input the design parameter combinations into the simulation software, so that multiple simulation results are automatically generated. The simulation software may be, for example, simulation design software for an electric motor of an electric vehicle, but the disclosure is not limited thereto. In one embodiment, the motor parameter search system 100 may also be applied to the design of various motor equipment, and the design parameters may also be, for example, related mechanical parameters, electrical related parameters, magnetic related parameters, thermal related parameters, etc.

In this embodiment, the motor parameter search system 100 may be, for example, a personal computer (PC), a laptop (notebook), a tablet, or other related equipment with computing capabilities, but the disclosure is not limited thereto. In one embodiment, the motor parameter search system 100 may also be implemented in the form of a cloud server.

In this embodiment, the processing device 110 may include, for example, a central processing unit (CPU), or other programmable general-purpose or special-purpose microprocessor, an image processing unit (IPU), a graphics processing unit (GPU), a digital signal processor (DSP), a programmable controller, an application specific integrated circuit (ASIC), a programmable logic device (PLD), or other similar computing circuits, or a combination of these circuits.

In this embodiment, the input device 120 may include, for example, a mouse and a keyboard, but the disclosure is not limited thereto. In one embodiment, the input device 120 may be an independent touch panel or integrated with a display panel.

In this embodiment, the storage device 130 may include a non-volatile memory such as a read only memory (ROM), an erasable programmable read only memory (EPROM), a volatile memory such as a random access memory (RAM), and storage devices such as a hard disc drive and a semiconductor memory, etc. The storage device 130 may be configured to store various parameters, modules, simulation software and other data mentioned in the disclosure.

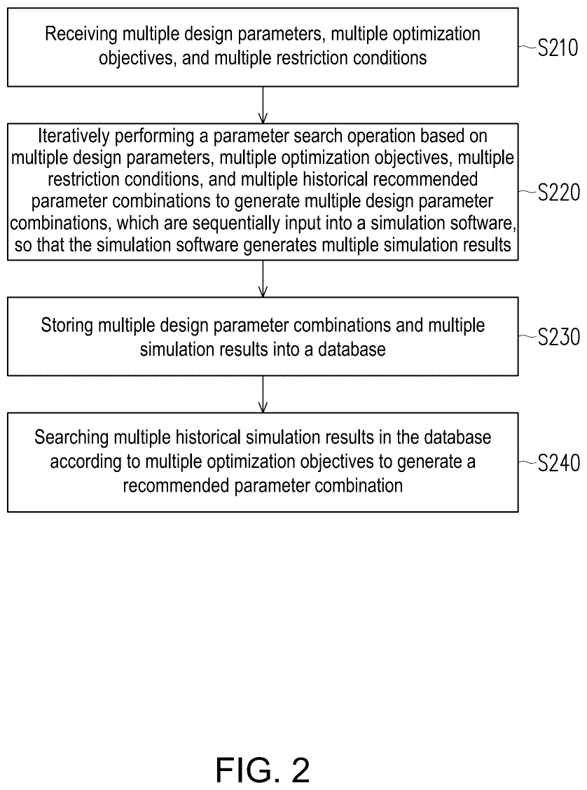

FIG. 2 is a flowchart of a motor parameter searching method of an embodiment of the disclosure. Referring to FIG. 1 and FIG. 2, the motor parameter search system 100 may perform the following steps S210 to S240. In step S210, the input device 120 may receive multiple design parameters, multiple optimization objectives, and multiple restriction conditions. In step S220, the processing device 110 may iteratively perform a parameter search operation according to the design parameters, the optimization objectives, the restriction conditions, and multiple historical recommended parameter combinations to generate multiple design parameter combinations, which are sequentially input into a simulation software, so that the simulation software generates multiple simulation results. In step S230, the processing device 110 may store the design parameter combinations and the simulation parameter results into a database, in which the database may be established in the storage device 130. In step S240, the processing device 110 may search multiple historical simulation results in the database according to the optimization objectives to generate a recommended parameter combination.

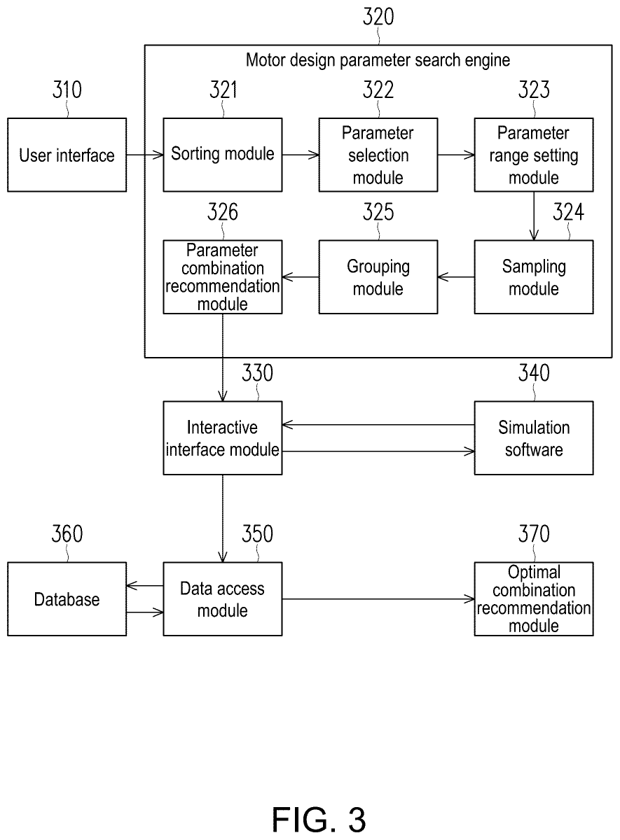

Specifically, referring to FIG. 3, FIG. 3 is a schematic diagram of multiple modules of the motor parameter search system of an embodiment of the disclosure. In this embodiment, the storage device 130 may, for example, store related programs and software of the user interface 310, the motor design parameter search engine 320, the interactive interface module 330, the simulation software 340, the data access module 350, the database 360 and the optimal combination recommendation module 370. In this embodiment, the user interface 310 can, for example, display a relevant operation screen through a display equipment, and the user may input multiple design parameters, multiple optimization objectives, and multiple restriction conditions according to relevant operation screens through the operation of the input device 120.

For example, the design parameters may be multiple motor design parameters. The motor design parameters may include stator core length, number of turns, wire diameter, fin height, rotation speed, current, etc. The optimization objectives may include cost reduction (i.e., design parameters corresponding to the stator core length and fin height), power greater than 6000 watts (i.e., design parameters corresponding to the rated power), torque improvement (i.e., the design parameter corresponding to the maximum torque), and efficiency greater than 92% (i.e., the design parameter corresponding to system efficiency), etc. The restriction conditions may include back electromotive force lower than 5, magnet temperature lower than 150 degrees, torque ripple less than 0.5, and tank full rate lower than 85%, etc.

In this embodiment, the processing device 110 may execute the motor design parameter search engine 320 so that the motor design parameter search engine 320 may iteratively perform a parameter search operation according to multiple design parameters, multiple optimization objectives, multiple restriction conditions, and multiple historical recommended parameter combinations to generate multiple design parameter combinations. The historical recommended parameter combinations may be stored in the database 360. Then, the interactive interface module 330 may sequentially input these design parameter combinations into the simulation software 340, so that the simulation software 340 generates multiple simulation results. The data access module 350 may store these design parameter combinations and these simulation results into the database 360. The optimal combination recommendation module 370 may search multiple historical simulation results in the database 360 according to these optimization objectives to generate a recommended parameter combination. In this embodiment, the motor design parameter search engine 320 may further include a sorting module 321, a parameter selection module 322, a parameter range setting module 323, a sampling module 324, a grouping module 325, and a parameter combination recommendation module 326.

In this embodiment, the sorting module 321 may sort these optimization objectives. The sorting module 321 may determine the optimization stage stratification and the optimization objectives used in different optimization stages according to the importance of the optimization objectives input by the user and the sorting result. In this regard, the sorting module 321 may use an analytical model method or an expert method to sort the importance of these optimization objectives. The sorting module 321 may determine multiple first-stage optimization objectives and a second-stage optimization objective according to the sorting result of the optimization objectives, so that the motor design parameter search engine 320 may iteratively respectively perform the first-stage and second-stage parameter search operations according to these first-stage optimization objectives and second-stage optimization objectives.

For example, if the optimization objectives input by the user may include cost, efficiency or power, among which power is the most important objective, the sorting module 321 may divide the parameter search operation into two stages. The first stage uses multi-objective optimization to perform a broad and rough parameter search operation, while the second stage uses the most important objective (e.g., power) to perform a single-objective search to effectively perform parameter optimization, which may enhance the parameter search for the most important objective.

In this embodiment, the parameter selection module 322 may select multiple important design parameters from these design parameters according to these optimization objectives. In this regard, since the number of parameters that need to be searched may be too large, it may take too much time to search for parameters due to the large amount of parameter data. Therefore, the motor design parameter search engine 320 may train the regression model by using historical reference points and perform parameter importance calculations. The motor design parameter search engine 320 may analyze historical parameter combinations to select design parameters that are important to the optimization objective for parameter search (e.g., select the design parameters with the highest importance for subsequent parameter searches), thereby improving search efficiency.

In this embodiment, the parameter range setting module 323 may set multiple search ranges for these important design parameters. The parameter range setting module 323 may be determined by analyzing historical parameter search data, or may also be determined based on manual settings by the user. In this embodiment, the sampling module 324 may sample multiple corresponding historical recommended parameter combinations according to these optimization objectives and these search ranges for use by subsequent modules.

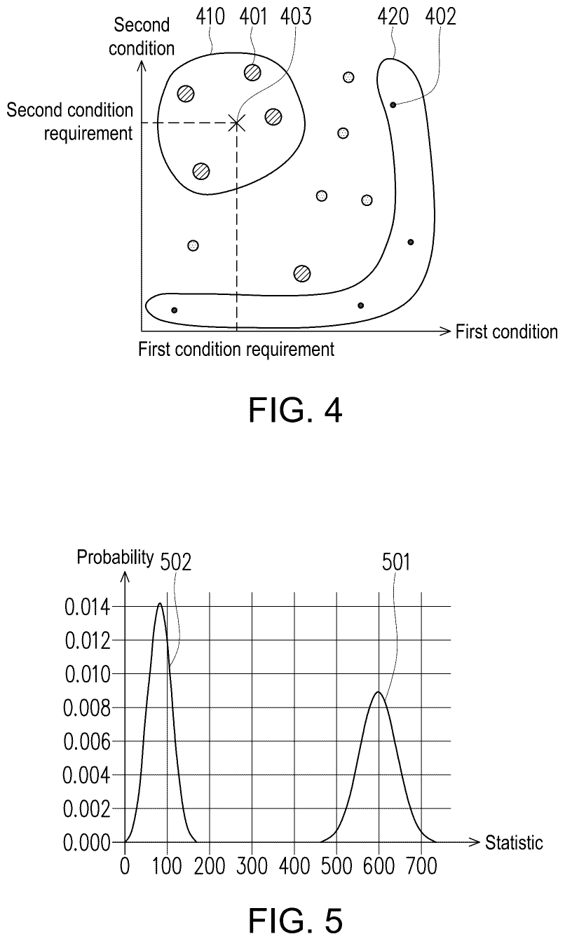

In this embodiment, the grouping module 325 may group these historical recommended parameter combinations to generate a first parameter combinations group and a second parameter combinations group. The grouping module 325 may group these historical recommended parameter combinations according to the restriction conditions and the search objective input by the user. Referring to FIG. 4, FIG. 4 is a schematic diagram of grouping of an embodiment of the disclosure. Distribution results of multiple first reference points 401 and multiple second reference points 402 of the first parameter combinations group 410 and the second parameter combinations group 420 on the distribution plane of the first condition (e.g., first design parameter) and the second condition (e.g., second design parameter) are taken as an example, in which the reference point 403 of the constraint condition may be the intersection point of the first condition requirement and the second condition requirement. In this regard, as shown in FIG. 4, the distance between the first reference points 401 of the first parameter combinations group 410 and the reference point 403 of the constraint condition is less than the distance between the second reference points 402 of the second parameter combinations group 420 and the reference point 403 of the constraint condition. Moreover, the objective values of the first reference points 401 are greater than the objective values of the second reference points 402. These first reference points 401 respectively correspond to good and poor parameter combination samples, and each group has multiple parameter combination samples. The quality of the parameter combination sample may be determined, for example, by the distance from the reference point 403 of the constraint condition.

In this embodiment, the parameter combination recommendation module 326 generates multiple design parameter combinations according to the optimization objectives, the first parameter combinations group 410, and the second parameter combinations group 420. In this regard, the parameter combination recommendation module 326 may respectively establish a distribution surrogate model for the first parameter combinations group and the second parameter combinations group, and calculate the acquisition function to generate the next design parameter combination for iterative calculation. Referring to FIG. 5, FIG. 5 is a probability distribution diagram of an embodiment of the disclosure. The parameter combination recommendation module 326 may calculate multiple first reference points 401 of the first parameter combinations group 410 and multiple second reference points 402 of the second parameter combinations group 420 in FIG. 4 by using the Parzen window density estimation method 402 probability distribution to generate probability distribution 501 and probability distribution 502 as shown in FIG. 5. The first reference points 401 of the first parameter combinations group 410 of FIG. 4 may correspond to the probability distribution 501, and the second reference points 402 of the second parameter combinations group 420 of FIG. 4 may correspond to the probability distribution 502. The parameter combination recommendation module 326 may use the formula of the expected improvement method as the acquisition function, so that the expected sampling point may have a higher probability in the probability distribution 501 and a lower probability in the probability distribution 502.

In this embodiment, the parameter combination recommendation module 326 may output the design parameter combination generated each time in the iterative search to the interactive interface module 330, so that the interactive interface module 330 may respectively input the design parameter combination generated each time in the iterative search to the simulation software 340. The simulation software 340 may automatically perform design simulation to generate multiple simulation results and return them to the interactive interface module 330. Then, the interactive interface module 330 may store these simulation results and corresponding design parameter combinations into the database 360 through the data access module 350. Moreover, after the iterative search is ended, the data access module 350 may provide all historical simulation results and corresponding design parameter combinations to the optimal combination recommendation module 370, so that the optimal combination recommendation module 370 may select one of the multiple historical recommended parameter combinations that matches the design requirements and optimization objectives as the (optimal) recommended parameter combination. Therefore, the optimal combination recommendation module 370 may output the recommended parameter combination to the user, so that the user may design and manufacture the motor according to the recommended parameter combination, and effectively obtain the motor equipment that meets the requirements.

For example, in an exemplary embodiment of the disclosure, the user may input 7 design parameters as shown in Table 1 below according to the relevant operation screen, including the initial values and search ranges of these 7 design parameters. These 7 design parameters may include lamination length (stator lam length/magnet length/rotor lam length), number of turns (number of coils), parallel paths, wire diameter, fin extension, rotation speed, and current. Moreover, the optimization objectives input by the user may include, for example, cost (the smaller the better), efficiency (the bigger the better) and power (the bigger the better), the restriction conditions may include the recommended power being greater than or equal to 6000 watts (W) and the recommended torque being greater than or equal to 20 (Nm).

TABLE 1

| | | |
|---|---|---|
| Design parameter | Initial value | Search range |

| | | | |
|---|---|---|---|
| Lamination length | 50 | (mm) | 40-60 |
| Number of turns (number of | 15 | (turns) | 10-30 |
| coils) | | | |

| | | |
|---|---|---|
| Parallel paths | 1 | 2, 4, 7 |

| | | | |
|---|---|---|---|
| Wire diameter | 25 | (mm) | 23-48 |
| Fin extension | 3 | (mm) | 1-10 |
| Rotation speed | 5500 | (rpm) | 5000-6000 |
| Current | 110 | (ampere) | 90-300 |

In the multi-objective search of the first stage, the sorting module 321 may sort according to the expert method. For example, the sorting module 321 may make a determination according to power, system efficiency, and cost.

In this example, the parameter selection module 322 may sort the importance of design parameters according to optimization objectives such as cost, power, and system efficiency. The parameter selection module 322 may train the regression model by using historical reference points to perform parameter importance calculations and select design parameters according to parameter importance. In this regard, since the search has not yet started, the design parameters remain unchanged and remain as the 7 shown in Table 1. The parameter range setting module 323 may determine the design parameters to be used and set the search range of these design parameters (as shown in Table 1).

Then, the parameter combination recommendation module 326 may read the historical reference points (i.e., historical recommended combinations) from the database 360. If the number of historical reference points does not meet the minimum required number, the sampling module 324 may generate the recommended design parameter combinations. For example, if the historical reference point requires at least 10 entries, then after the search starts, the first 10 recommended combinations may be recommended by the sampling module 324. In addition, if there is no historical reference point, the sampling module 324 randomly generates a combination within the design parameter range. Moreover, the grouping module 326 may group historical reference points. In this regard, if the historical reference points have met the minimum required number, the grouping module 326 divides the historical reference points into groups. For example, the parameter combination recommendation module 326 may obtain the result of the grouping module 325 grouping 10 historical reference points. The 10 historical reference points may be divided, for example, into two groups: “good” and “bad”. The parameter combination recommendation module 326 may generate a new recommended parameter combination according to the grouped historical reference points. Then, in this example, the interactive interface module 330 may transmit the new recommended parameter combination generated by the parameter combination recommendation module 326 to the simulation software 340, and obtain the simulation results generated by the simulation software 340. The system may perform the above operations repeatedly until the maximum search count is reached. Finally, the optimal combination recommendation module 370 may obtain all historical reference points through the data access module (including all recommended parameter combinations newly added by the system repeatedly performing the above operations), and select and output the parameter optimization result of the optimal combination as shown in Table 2 below, in which the cost, power, system efficiency, and torque of the optimization objectives may be effectively improved.

TABLE 2

| Optimization | Design | | | First stage optimization | |
|---|---|---|---|---|---|
| Objective | parameter | Initial value | | result | |
| | Lamination length | 50 | (mm) | 60 | (mm) |
| | Number of turns | 15 | (turns) | 10 | (turns) |
| | (number of coils) | | | | |
| | Parallel paths | 1 | | 4 | |
| | Wire diameter | 25 | (mm) | 26 | (mm) |
| | Fin extension | 3 | (mm) | 4.8 | (mm) |
| | Rotation speed | 5500 | (rpm) | 5700 | (rpm) |
| | Current | 110 | (ampere) | 199 | (ampere) |
| Cost | | 100 | | 95 | |
| Power | | 5952.50 | (watt) | 5832.14 | (watt) |
| System efficiency | | 92.45% | | 92.994% | |
| Torque | | 12.337 | (Nm) | 14.102 | (Nm) |

In the single-objective search of the second stage, the parameter selection module 322 may sort the importance of design parameters according to a single optimization objective (e.g., power). The parameter selection module 322 may train the regression model by using historical reference points to perform parameter importance calculations to find parameters that have an impact on power adjustment. In this regard, as shown in Table 3 below, for example, the top 5 important parameters may be selected according to their importance. In addition, the recommended (optimized) values generated in the first stage may be adopted for design parameters that were not selected. The parameter range setting module 323 may determine the design parameters to be used and set the search range of these design parameters (as shown in Table 3).

TABLE 3

| | | |
|---|---|---|
| Design parameter | Initial value | Search range |

| | | | |
|---|---|---|---|
| Lamination length | 60 | (mm) | 40-60 |
| Number of turns (number of | 10 | (turns) | 10-30 |
| coils) | | | |
| Wire diameter | 26 | (mm) | 23-48 |
| Rotation speed | 5700 | (rpm) | 5000-6000 |
| Current | 199 | (ampere) | 90-300 |

Then, the parameter combination recommendation module 326 may read the historical reference points generated in the first stage (i.e., historical recommended combinations) from the database 360. Moreover, since the single-objective search of the second stage may use the historical reference points in the first stage, there is no need to execute the sampling module 324. Furthermore, the grouping module 326 may group at least a portion of the historical reference points of the first stage. The parameter combination recommendation module 326 may generate a new recommended parameter combination according to the grouped historical reference points. Then, in this example, the interactive interface module 330 may transmit the new recommended parameter combination generated by the parameter combination recommendation module 326 to the simulation software 340, and obtain the simulation results generated by the simulation software 340. The interactive interface module 330 may store the simulation results in the database 360 (i.e., as a new historical reference point). The system may perform the above operations repeatedly until the maximum search count is reached. Finally, the optimal combination recommendation module 370 may obtain all historical reference points through the data access module (including all recommended parameter combinations newly added by the system repeatedly performing the above operations). The optimal combination recommendation module 370 may filter out simulation results with power less than 6000 watts (W) and torque less than 20 (Nm) based on the above restriction conditions. Therefore, the optimal combination recommendation module 370 may select and output the parameter optimization result of the optimal combination as shown in Table 4 below, in which the power of the main optimization objective (single objective) may be further effectively improved.

TABLE 4

| | | | | First stage | | Second stage | |
|---|---|---|---|---|---|---|---|
| Optimization | Design | | | optimization | | optimization | |
| Objective | parameter | Initial value | | result | | result | |
| | Lamination | 50 | (mm) | 60 | (mm) | 62 | (mm) |
| | length | | | | | | |
| | Number of | 15 | (turns) | 10 | (turns) | 22 | (turns) |
| | turns | | | | | | |
| | (number of | | | | | | |
| | coils) | | | | | | |
| | Parallel paths | 1 | | 4 | | 4 | |
| | Wire | 25 | (mm) | 26 | (mm) | 32 | (mm) |
| | diameter | | | | | | |
| | Fin extension | 3 | (mm) | 4.8 | (mm) | 9.2 | (mm) |
| | Rotation | 5500 | (rpm) | 5700 | (rpm) | 5350 | (rpm) |
| | speed | | | | | | |
| | Current | 110 | (ampere) | 199 | (ampere) | 148.7 | (ampere) |
| Cost | | 100 | | 95 | | 96 | |
| Power | | 5952.50 | (watt) | 5832.14 | (watt) | 6052.58 | (watt) |
| System efficiency | | 92.45% | | 92.994% | | 92% | |
| Torque | | 12.337 | (Nm) | 14.102 | (Nm) | 20 | (Nm) |

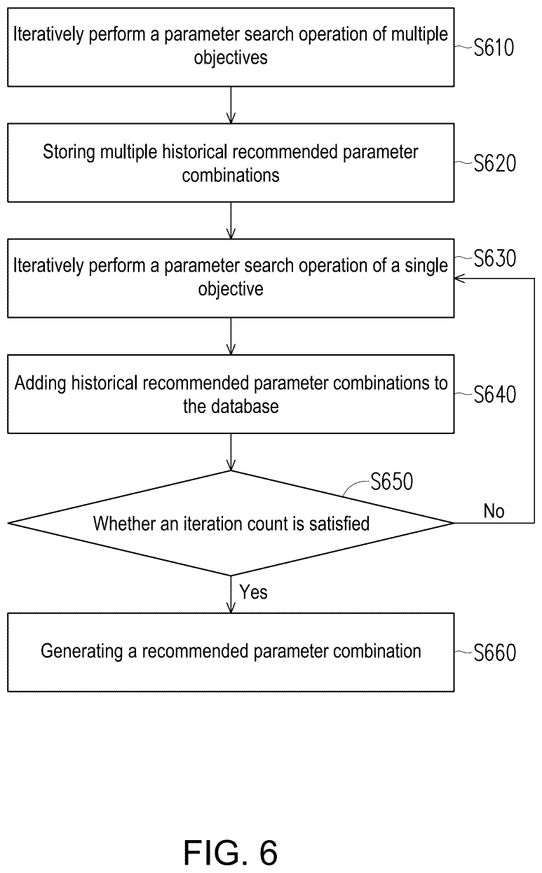

FIG. 6 is a flowchart of a two-stage iterative search operation of an embodiment of the disclosure. Referring to FIG. 1, FIG. 3 and FIG. 6, the motor parameter search system 100 may perform the following steps S610-S650. In step S610, the processing device 110 may first iteratively perform a parameter search operation of multiple objectives. In this regard, the motor design parameter search engine 320 may first perform a parameter search according to multiple optimization objectives to generate multiple recommended parameter combinations, which are input into the simulation software 340 to generate multiple corresponding simulation results. In step S620, the database 360 may store multiple historical recommended parameter combinations generated by the iteratively performed parameter search operation of multiple objectives to increase the number of samples required for the next stage of parameter search. In this embodiment, the processing device 110 may iteratively perform a parameter search operation of multiple objectives according to a fixed iteration count.

In step S630, the processing device 110 may iteratively perform a parameter search operation of a single objective. In this regard, the motor design parameter search engine 320 may perform a parameter search according to a single optimization objective (an important optimization objective) to generate a recommended parameter combination, which is input into the simulation software 340 to generate a corresponding simulation result. In step S640, the processing device 110 may add historical recommended parameter combinations to the database 360. In step S650, the processing device 110 may determine whether the current performed parameter search count meets the iteration count. If so, the optimal combination recommendation module 370 may generate a recommended parameter combination in step S660. If not, the processing device 110 may perform the parameter search operation of a single objective again.

In this regard, the samples of the historical recommended parameter combinations added in each search operation may be added to the first parameter combinations group and the second parameter combinations group generated by the grouping module 325, thereby the number of samples of may be added. In this way, the reasonable sample rate of parameter search may be effectively improved, and the relevant values or parameters corresponding to the important optimization objectives (i.e., the above-mentioned second-stage optimization objectives) may be further optimized.

In summary, the motor parameter search system and the motor parameter search method of the disclosure may perform parameter search operations for multiple optimization objectives and a single optimization objective, and the parameter search operation for a single optimization objective may be performed with the selection of an important design parameter, so as to effectively improve the reasonable sample rate of parameter search. Therefore, the motor parameter search system and the motor parameter search method of the disclosure may automatically and effectively generate the optimal recommended parameter combination for motor manufacturing.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. A motor parameter search system, comprising:
a processing device, executing a motor design parameter search engine, an interactive interface module, a data access module, a simulation software, and an optimal combination recommendation module; and
an input device, coupled to the processing device and receiving a plurality of design parameters, a plurality of optimization objectives, and a plurality of restriction conditions,
wherein the motor design parameter search engine iteratively performs a parameter search operation according to the design parameters, the optimization objectives, the restriction conditions, and a plurality of historical recommended parameter combinations to generate a plurality of design parameter combinations, and the interactive interface module sequentially inputs the design parameter combinations into the simulation software, so that the simulation software generates a plurality of simulation results,
wherein the data access module stores the design parameter combinations and the simulation results into a database, the optimal combination recommendation module searches a plurality of historical simulation results in the database according to the optimization objectives to generate a recommended parameter combination.

2. The motor parameter search system according to claim 1, wherein the motor design parameter search engine comprises a sorting module, and the sorting module sorts the optimization objectives,
wherein the sorting module determines a plurality of first-stage optimization objectives and a second-stage optimization objective according to a sorting result of the optimization objectives, and the motor design parameter search engine iteratively performs the parameter search operation of a first stage and a second stage according to the first-stage optimization objectives and the second-stage optimization objective respectively.

3. The motor parameter search system according to claim 1, wherein the motor design parameter search engine comprises a parameter selection module, and the parameter selection module selects a plurality of important design parameters from the design parameters according to the optimization objectives,
wherein the motor design parameter search engine further comprises a parameter range setting module, and the parameter range setting module sets a plurality of search ranges for the important design parameters,
wherein the motor design parameter search engine further comprises a sampling module, and the sampling module samples the historical recommended parameter combinations according to the optimization objectives and the search ranges.

4. The motor parameter search system according to claim 3, wherein the motor design parameter search engine further comprises a grouping module, and the grouping module groups the historical recommended parameter combinations to generate a first parameter combinations group and a second parameter combinations group,
wherein the motor design parameter search engine further comprises a parameter combination recommendation module, and the parameter combination recommendation module generates the design parameter combinations according to the optimization objectives, the first parameter combinations group and the second parameter combinations group,
wherein the grouping module groups the historical recommended parameter combinations according to the restriction conditions and a search objective.

5. The motor parameter search system according to claim 4, wherein a distance between a plurality of reference points of the first parameter combinations group and a reference point of a constraint condition in a grouping diagram is less than a distance between a plurality of reference points of the second parameter combinations group and the reference point of the constraint condition in the grouping diagram.

6. The motor parameter search system according to claim 4, wherein the parameter combination recommendation module respectively establishes a distribution surrogate model for the first parameter combinations group and the second parameter combinations group, and calculates an acquisition function to generate a next design parameter combination for iterative calculation.

7. A motor parameter search method, comprising:
receiving a plurality of design parameters, a plurality of optimization objectives, and a plurality of restriction conditions;
iteratively performing a parameter search operation according to the design parameters, the optimization objectives, the restriction conditions, and a plurality of historical recommended parameter combinations to generate a plurality of design parameter combinations which are sequentially input into a simulation software, so that the simulation software generates a plurality of simulation results;
storing the design parameter combinations and the simulation results into a database; and
searching a plurality of historical simulation results in the database according to the optimization objectives to generate a recommended parameter combination.

8. The motor parameter search method according to claim 7, wherein iteratively performing the parameter search operation according to the design parameters, the optimization objectives, the restriction conditions, and the historical recommended parameter combinations comprises:
determining a plurality of first-stage optimization objectives and a second-stage optimization objective according to a sorting result of the optimization objectives; and
iteratively performing the parameter search operation of a first stage and a second according to the first-stage optimization objectives and the second-stage optimization objective respectively.

9. The motor parameter search method according to claim 7, wherein iteratively performing the parameter search operation according to the design parameters, the optimization objectives, the restriction conditions, and the historical recommended parameter combinations comprises:
selecting a plurality of important design parameters from the design parameters according to the optimization objectives;
setting a plurality of search ranges of the important design parameters; and
sampling the historical recommended parameter combinations according to the optimization objectives and the search ranges.

10. The motor parameter search method according to claim 9, wherein iteratively performing the parameter search operation according to the design parameters, the optimization objectives, the restriction conditions, and the historical recommended parameter combinations further comprises:
grouping the historical recommended parameter combinations to generate a first parameter combinations group and a second parameter combinations group; and
generating the design parameter combinations according to the optimization objectives, the first parameter combinations group, and the second parameter combinations group,
wherein grouping the historical recommended parameter combinations comprises:
grouping the historical recommended parameter combinations according to the restriction conditions and a search objective.

11. The motor parameter search method according to claim 10, wherein a distance between a plurality of reference points of the first parameter combinations group and a reference point of a constraint condition in a grouping diagram is less than a distance between a plurality of reference points of the second parameter combinations group and the reference point of the constraint condition in the grouping diagram.

12. The motor parameter search method according to claim 10, wherein iteratively performing the parameter search operation according to the design parameters, the optimization objectives, the restriction conditions, and the historical recommended parameter combinations further comprises:
respectively establishing a distribution surrogate model for the first parameter combinations group and the second parameter combinations group; and
calculating an acquisition function to generate a next design parameter combination for iterative calculation.
